(19) United States
(12) Patent Application Publication
(10) Pub. No.: US 2023/0291788 A1
(43) Pub. Date: Sep. 14, 2023

(54) Dynamically Providing Context-Based Computer-Supported Functionalities in Mobile Distributed Edge Clouds

(71) Applicant: Siemens Aktiengesellschaft, München (DE)

(72) Inventors: Markus Sauer, München (DE); Florian Zeiger, Höhenkirchen-Siegertsbrunn (DE); Hans-Peter Huth, München (DE)

(73) Assignee: Siemens Aktiengesellschaft, München (DE)

(21) Appl. No.: 18/006,638

(22) PCT Filed: Jul. 9, 2021
(86) PCT No.: PCT/EP2021/069193

§ 371 Date: Jan. 24, 2023

(30) Foreign Application Priority Data
Jul. 29, 2020 (EP) 20188412.9

(51) Int. Cl. H04L 67/10

(52) U.S. Cl. CPC H04L 67/10

(57) ABSTRACT

Various embodiments of the teachings herein include an automated method for providing functionalities of a mobile unit for carrying out a function of a request unit required separately from the mobile unit. The method may include: providing the required function in the mobile unit; and carrying out the function based on a context. A context rule system is provided in the mobile unit for carrying out the function. The function is carried out in the mobile unit only if one or more rules of the context rule system are satisfied.

### CROSS-REFERENCE TO RELATED APPLICATIONS

This application is a U.S. National Stage Application of International Application No. PCT/EP2021/069193 filed Jul. 9, 2021, which designates the United States of America, and claims priority to EP Application No. 20188412.9 filed Jul. 29, 2020, the contents of which are hereby incorporated by reference in their entirety.

### TECHNICAL FIELD

The disclosure relates to cloud systems. Various embodiments include automated methods and/or systems for providing functionalities of a mobile unit for at least one function of a request unit required separately from the mobile unit.

### BACKGROUND

New business models and new developments in the technical field result in an increasing need for computing capacity and computing functionality in close proximity to incoming data or to actuators in the field. This is caused not only by new technical capabilities, but above all by technical limitations, such as, for example, the inability to transmit large volumes of data. Today, typical architectures upload, for example, all data captured by sensors into a cloud application where the data are processed and the derived actions are forwarded to the systems in the field. However, due in part to the huge volumes of data and prevailing broadband restrictions or other application requirements (e.g. low latency), this is not actually possible or is simply not appropriate or not feasible with the known technical capabilities.

Typical examples of applications in the smart city/mobility environment are autonomous vehicles in which a communication infrastructure would perhaps still be possible, but is inappropriate. The vehicles generate roughly 4000 GB/day of data which are used primarily for locally relevant decisions. A transfer of these data volumes into cloud applications is inappropriate, costly and can possibly also conflict with other requirements, such as, for example, latency.

A further example relates to applications in an agricultural or offshore maritime environment. New data-intensive applications with data analytics, artificial intelligence or autonomy functions can no longer be realized with hierarchical static cloud architectures due to inadequate communication infrastructure. The work areas tackling these issues of communication resource provision in the field are edge and fog computing. Solutions are typically proposed today in which the applications to be executed and the execution of the environments are planned during the system design and, if necessary, computing resources are also provided according to requirements in the form of additional edge nodes. Edge nodes are devices with computing power, memory and communication capabilities which are typically positioned between the terminal devices and a cloud and—similar to a data center—can execute any application.

However, this takes no account of either the possible mobility of edge resources, for example vehicles with computing power, such as automobiles, tractors, ships, aircraft, etc., or the potential dynamics of tasks which are intended to be carried out by the forming dynamic edge cloud, e.g. new data collections at selected locations, communication tasks, analysis tasks, etc.

### SUMMARY

The teachings of the present disclosure describe methods and/or systems for making mobile, unused computing resources available to system in a simple and cost-effective manner. For example, some embodiments include an automated method for providing functionalities of at least one mobile unit (1) for carrying out at least one function of a request unit (2) required separately from the mobile unit, wherein the required function is provided (101) in the mobile unit (1), wherein the function is carried out based on the context, wherein a context rule system is provided (102) in the mobile unit (1) for carrying out the function, and wherein the function is carried out (103) in the mobile unit (1) if one or more rules of the context rule system are satisfied.

In some embodiments, the mobile unit (1) is an edge node of an edge cloud (5) and the request unit (2) is a part of the edge cloud (5).

In some embodiments, once the function has been carried out, the result is transmitted (104) to the request unit (2) according to the context rule system.

In some embodiments, the context rule system and the at least one function are provided redundantly on at least two mobile units (1) on the basis of a prediction model, wherein the prediction model is designed to achieve a predefined probability of performing the function by means of the provided redundancy.

In some embodiments, the mobile unit (1) is configured to inform further mobile units (1) which rules have triggered in the mobile unit (1) and which function is carried out.

In some embodiments, the request unit (2) is configured to convey the importance and/or urgency of carrying out the function to the mobile unit (1).

As another example, some embodiments include a system (5), characterized by: at least one request unit (2), at least one mobile unit (1) which is configured to provide functionalities for at least one function of the request unit (2) required separately from said mobile unit (1), and to carry out said function as required, wherein the function is carried out based on the context, and a rule engine module (1.2) formed in the mobile unit (1) which is configured to carry out the function on the basis of a context rule system stored in the rule engine module (1.2), wherein the function is carried out in the mobile unit (1) or the function already being carried out is stopped if one or more rules of the context rule system are satisfied.

In some embodiments, a function runtime module (1.3) formed in the mobile unit (1) is configured to instantiate the function and carry it out in isolation from further functions.

In some embodiments, a context management module (1.1) formed in the mobile unit (1) is configured to determine the current context of the mobile unit (1).

In some embodiments, a rule management module (1.4) formed in the mobile unit (1) is configured to provide the context rule system.

In some embodiments, a function repository module (1.5) formed in the mobile unit (1) is configured to store the functions which are potentially intended to be carried out and to make them available to the function runtime module.

In some embodiments, a context predictor module (1.6) formed in the mobile unit (1) is configured to predict the context of the mobile unit (1).

In some embodiments, a context sensor module (1.8) formed in the mobile unit (1) is configured to generate information relating to the context, in particular data from sensors.

In some embodiments, a movement, path, coverage and context predictor component (4) is configured to predict contexts for the components of the system (5), in particular movement profiles, and make them available to the mobile unit (1).

In some embodiments, the system is an edge cloud (5) and the mobile unit is an edge node (1).

### BRIEF DESCRIPTION OF THE DRAWINGS

Further features and advantages of the teachings herein are set out in the following explanations of an exemplary embodiment with reference to schematic drawings. In the drawings:

FIG. 1 shows a block diagram of an exemplary embodiment incorporating teachings of the present disclosure; and

FIG. 2 shows a flow diagram of a method for context-related provision of computing power incorporating teachings of the present disclosure.

### DETAILED DESCRIPTION

One aspect of the teachings herein comprises exploiting the potential mobility of units, such as edge nodes, whereby, through (technically) cost-effective, redundant provision of rules and corresponding function templates, this functionality can be made available to other components of the system by means of prediction mechanisms. It thereby becomes possible to make unused computing resources accessible to a system in a dynamic and context-dependent manner and, for example, to use them appropriately for data-intensive functions in, for example, mobile edge cloud use cases. Applications, in particular, which are not possible or are possible to a restricted extent only according to the prior art due to communication restrictions and cost restrictions also become possible as a result.

A similar dynamic, cost-dependent solution is not previously known. Current approaches solve the problem by providing adequate local computing resources or by providing communication connections, although the latter are not used for a large part of the operating time. Many desirable new mobile edge cloud applications are not implementable with current concepts.

A cloud-based or edge-cloud-based IoT application includes a plurality of virtual and physical computing units, data sources, actuators, functions, services, etc., which implement one or more system-wide complete applications through communication. In current IoT systems, each subfunction (e.g. service application or analysis function) of a component is typically assigned in a dedicated manner in the system at the time of design. In the system according to the invention, functions or subfunctions of this type are requested dynamically in runtime by system components, for example an agricultural operation with its farm management system on a smartphone of a farmer, and are then executed in a context-specific manner. The executing edge nodes are potentially mobile and the context (in particular spatial) is therefore not fixed and normally also non-deterministic.

In some embodiments, functional requirements consist of one or more rules of a context rule system (e.g. “mobile edge node in area x, y” and “it is raining at the same time in area x, y”), a description of the edge node characteristics and the corresponding task or function in the form e.g. of a script to be run, a function container, an application or a network configuration. This tuple comprising the function and rules is introduced into the system and transferred onto mobile units, such as edge nodes, which come into consideration for this task. Mobile units are described by the functionality which they provide, the hardware and operating system characteristics, and also non-functional characteristics, such as e.g. security features (IT security), costs, ownership, current location, etc.

The assignment of the functions can take place according to permanently programmed sequences or through a central or local prediction component which predicts the future contexts for the system and therefore determines, with sufficient reliability, a set of potential mobile units on which the functions or tasks could potentially be carried out in future.

If a function or task is transferred onto a mobile unit, it is initially not executed immediately there. Instead, the rules are installed on this mobile unit in a rule engine via a rule management and the function is stored on the mobile unit in a function repository or the like.

If the mobile unit, i.e., for example, the edge node, moves into the corresponding context, or if the mobile unit is already located in the corresponding context so that the rule system triggers a predefined task, the corresponding function is instantiated and carried out on the mobile unit. As soon as the function/task is completed, the result is transmitted according to predefined rules to the corresponding initiator (=request unit).

In some embodiments, the rules and functions are provided simultaneously on a plurality of mobile units on the basis of the corresponding predictions in order to achieve a sufficient probability, by means of a redundancy of this type, that a task or function will be carried out. In an extreme case, the task or function is assigned to all mobile units of the system.

Such a system allows, for example: dynamic utilization of unused resources on, for example, mobile edge and IoT devices; provision of functionalities is reduced to a storage space for the provision of the functionality and the rules which result in carrying out the functions—the system thus incurs no costs (e.g. energy consumption to carry out the function) and other functions carried out on the system are not affected; a context-related deployment mechanism for functions and software components which may only have low-bandwidth communication connections; and/or the autonomy of a device, e.g. in the event of communication failure, is increased.

Some example embodiments include an automated, in particular computer-implemented method for providing functionalities of at least one mobile unit for carrying out at least one function of a request unit required separately from the mobile unit, wherein the required function is provided in the mobile unit, wherein the function is carried out based on the context, wherein a context rule system is provided in the mobile unit for carrying out the function, and wherein the function is carried out in the mobile unit if one or more rules of the context rule system are satisfied.

Context in the IT environment means any type of information which can be used to characterize the situation of one entity interacting with other entities. Since context depends on the respective interaction, it is not possible to give a general answer indicating whether an information element is context or not. Context can be an individual information element or a combination of many information elements from different sources or different times. Context forms the basis for context-sensitive applications. Context-sensitive or context-related refers to the behavior of application programs which use information relating to their “context”, i.e. their environment, in order to align their behavior therewith.

Functionalities are, for example, computing capacity or communication capacity. “Function” also includes carrying out a task or assignment. “Function” can also be referred to as “application program”.

In some embodiments, the mobile unit can be an edge node of an edge cloud and the request unit can be a part of the edge cloud.

In some embodiments, once the function has been carried out, the result can be transmitted to the request unit according to the context rule system. This means that the transmission back to the request unit is also performed by means of a rule-based procedure.

In some embodiments, the context rule system and the at least one function can be provided redundantly on at least two mobile units on the basis of a prediction model, wherein the prediction model is designed to achieve a predefined probability of performing the function by means of the provided redundancy.

In some embodiments, the mobile unit can be configured to inform further mobile units which rules have triggered in the mobile unit and which function is carried out.

In some embodiments, the request unit can be configured to convey the importance and/or urgency of carrying out the function to the mobile unit.

As another example, some embodiments include a system, having: at least one request unit, at least one mobile unit which is configured to provide functionalities for at least one of the request unit of the request unit, and to carry out said function as required, wherein the function is carried out based on the context, and a rule engine module formed in the mobile unit which is configured to carry out the function by means of a context rule system stored in the rule engine module, wherein, if one or more rules of the context rule system are satisfied, the function is carried out in the mobile unit or the function already being carried out is stopped.

In some embodiments, the system has a function runtime module formed in the mobile unit which is configured to instantiate the function and carry it out in isolation from further functions.

In some embodiments, the system has a context management module formed in the mobile unit which is configured to determine the current context of the mobile unit.

In some embodiments, the system has a rule management module formed in the mobile unit which is configured to provide the context rule system.

In some embodiments, the system has a function repository module formed in the mobile unit which is configured to store the functions which are potentially intended to be carried out, and to make them available to the function runtime module.

In some embodiments, the system has a context predictor module formed in the mobile unit which is configured to predict the context of the mobile unit.

In some embodiments, the system has a context sensor module formed in the mobile unit which is configured to generate information relating to the context, in particular to capture data from sensors.

In some embodiments, the system has a movement, path, coverage and context predictor component which is configured to predict contexts for the components of the system, in particular movement profiles, and make them available to the mobile unit.

In some embodiments, the system can be designed as an edge cloud and the mobile unit can be designed as an edge node.

Future IoT systems and edge cloud systems will consist of a multiplicity of different components. These components will also incorporate different characteristics into the system. Components will become increasingly mobile, or computing power will become increasingly available on mobile units. The task/functions to be performed and the existing communication infrastructure will further be location-dependent. A manual configuration of such a complex system is very elaborate and is also susceptible to error. In order to enable reliable operation of a complex and dynamic system topology of this type, the mechanisms described herein create an environment for automated and transparent planning, distribution and performance of functions/tasks.

In some embodiments, creation, for example on the basis of learning prediction mechanisms, of the technical capability to provide functions to be carried out, if necessary multiple times and redundantly. These functions are then transferred to performance status only if the context conditions have triggered. The context (see also relevant details above) can be determined here by means of physical quantities, object characteristics (e.g. geo-position, movement profiles, paths and coverage of the mobile unit, for example (edge) cloud or communication infrastructure) and/or environmental characteristics (e.g. presence of specific prerequisites such as an external energy source or local proximity of system components/users).

The context can also be determined by results from calculations (e.g. predictions based on AI algorithms or models, simulations, emulations, etc.), and can also be defined from a plurality of dependent or independent parameters. Commercial rules or user preferences can further be taken into account.

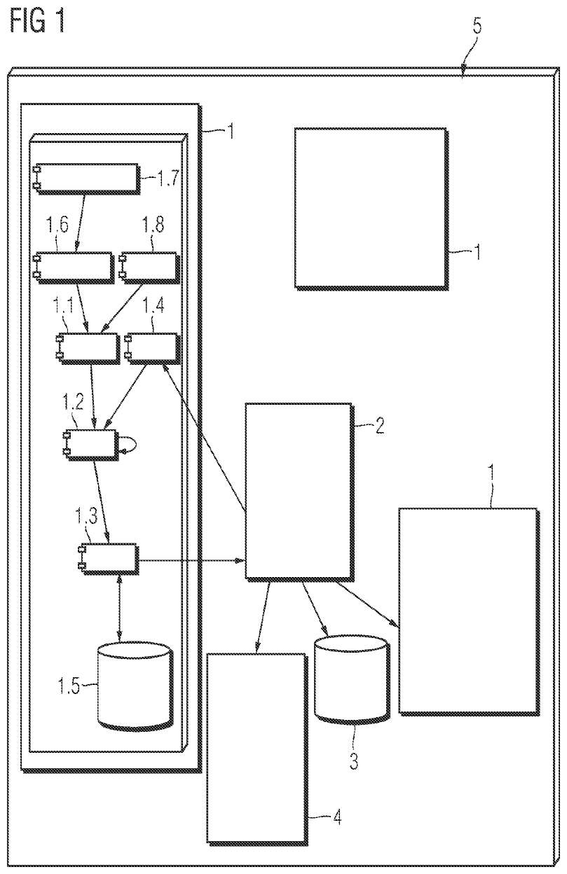

FIG. 1 shows, as an exemplary embodiment, a block diagram of a system having an edge cloud 5. The system has the following components:
A plurality of mobile edge nodes 1 which can potentially take charge of computing, communication and/or storage functions. These have, inter alia, the following modules:
   Context management module 1.1; a module for determining the current context of the edge node (e.g. current movement planning).
   Rule engine module 1.2; this module checks with every context change whether a set of rules for a function is satisfied or, in the case of performed functions, the rules no longer trigger. This information is forwarded to the function runtime module 1.3 and corresponding functions are either instantiated or stopped.
   Function runtime module 1.3; this module instantiates the corresponding functions and carries them out in isolation from other functions.
   Rule management module 1.4; this module provides the corresponding context rule system (a set of rules) which is intended to result in functions being carried out on the mobile edge node 1.
   Function repository module 1.5; this module stores all functions which are potentially intended to be carried out and makes them available to the other modules, in particular to the function runtime module 1.3.
   Local context predictor module 1.6; this is a local module for predicting the context on the edge node 1.
   Context history module 1.7; a module which stores the history of all relevant data for a context prediction.
   Context sensor module 1.8; a module which generates the context information, such as, for example, data from sensors or relating to functions.
A task/function creator component 2 as a request unit; this system component creates tasks which are intended to be carried out in the mobile edge cloud 3. To do this, a task is generated for the system in the component 2, for example from function templates, the corresponding parameters and a set of context rules, and the performance of the task is requested in the system. The request can be made e.g. manually, or automatically by a different automation component on the basis of event triggers.
An optional function repository component 3; it/they is/are one or more centrally or locally organized repositories which make possible functions available to other components in the form of e.g. containers, scripts, network functions, for example as templates.
Movement, path, coverage and context predictor component 4; a component which is logically implemented centrally or locally and makes context predictions (e.g. movement profiles) of the mobile edge nodes 1 available to the other components in the system. This component 4 can be implemented for each individual mobile edge node 1, for each customer/tenant (=request unit) in the system or for the entire ecosystem.

In some embodiments, a mobile edge node 1 informs the other potential mobile edge nodes 1 which rules have triggered in it and which functions it then performs and, where appropriate, also what the corresponding performance status is. The other mobile edge nodes 1 which provide the same function or task can then, for example, interpret this information so that they do not have to perform this function if corresponding rules trigger in them, since the function is already being performed by a different mobile edge node 1. Alternatively, the function can also be designed, for example, redundantly.

An edge node 1 can also use power-saving functions or can reduce the load on the main memory if certain applications are not currently required by stopping or transferring these functions or by carrying them out at reduced speed. The form of the response to this situation can, for example, also be predefined in the rules. An edge node 1 can also decline the request to carry out a function, e.g. if the battery state is low.

In some embodiments, the importance and urgency of carrying out the function are also incorporated into the task request. These factors can then be interpreted, for example, by cost functions, and the mobile edge nodes 1 can potentially be prompted to generate specific contexts deliberately, or, where appropriate, maintain them for longer (e.g. allowing for workarounds in order to guarantee that the function is carried out). This can also be configured so that these factors can also be incorporated in such a way that they are directly and technically geared towards a commercial function and, for example, are offered in a binding form with smart contracts in an open ecosystem and the performance is documented in falsification-proof form. Blockchain technology, for example, can be used for this purpose.

Functions for the system may include, for example:
“Data mule” data collection functions; if the mobile unit is in area a, then set up a connection via communication interface x to systems of type y, capture temperature sensor data, preprocess them according to function b, and upload the results data when passing station c which is intended to forward the data.
“Update/installation mule” deployment functions: if mobile unit passes components with the following characteristics x, y, upload the following update via a direct communication and authenticate yourself with the certificate z.
“Comm mule” communication gateway: if mobile unit is expected to remain for x hours in area a, b, make a communication link e with the service characteristics f available for 60 min to the components c, d.
“Analytics mule” analytics functions: if mobile unit is expected to remain for x hours in area a, b, collect the data from the local sensor types c, d for 60 min, analyze the data locally with model e and transmit the data via communication link f to g.

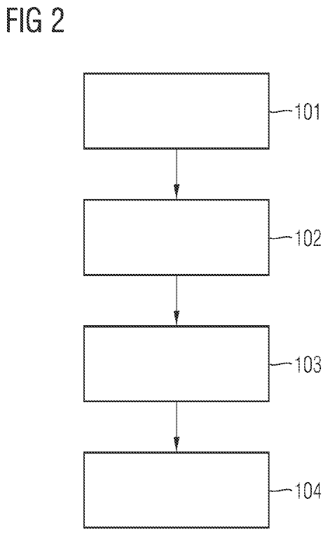

FIG. 2 shows a flow diagram of a method for providing functionalities of a mobile unit incorporating teachings of the present disclosure, for example a mobile edge node of an edge cloud, for a function of a request unit required separately from the mobile unit. The request unit can also be referred to as the task/function creator component.

In a first step 101, the function required by a request unit can be loaded and therefore made available in order to be carried out as required. In a second step 102, the context rule system to be used to carry out the function based on the context is loaded into the mobile unit and is therefore available in the mobile unit. In a third step 103, the function is carried out in the mobile unit if one or more rules of the context rule system are satisfied. In a concluding fourth step 104, the result of carrying out the function is transmitted to the request unit.

Although the teaching herein have been illustrated and described in detail by means of the exemplary embodiments, the scope of the disclosure is not restricted by the disclosed examples and other variations can be derived therefrom by a person skilled in the art without departing the protective scope of the disclosure.

### REFERENCE NUMBER LIST

1 Edge node
1.1 Context Management Module
1.2 Rule engine module
1.3 Function runtime module
1.4 Rule management module
1.5 Function repository module
1.6 Context predictor module
1.7 Context history module
1.8 Context sensor module
2 Task/function creator component
3 Function repository component
4 Movement, path, coverage and context predictor component
5 Edge cloud
101 Load a function
102 Load a rule system
103 Carry out the function
104 Transmit the results

What is claimed is:

1. An automated method for providing functionalities of a mobile unit for carrying out a function of a request unit required separately from the mobile unit, the method comprising:
providing the required function in the mobile unit; and
carrying out the function based on a context;
wherein a context rule system is provided in the mobile unit for carrying out the function; and
wherein the function is carried out in the mobile unit only if one or more rules of the context rule system are satisfied.

2. The method as claimed in claim 1, wherein the mobile unit comprises an edge node of an edge cloud and the request unit comprises a part of the edge cloud.

3. The method as claimed in claim 1, further comprising, once the function has been carried out, transmitting the result to the request unit according to the context rule system.

4. The method as claimed in claim 1, further comprising providing the context rule system and the function redundantly on at least two mobile units on the basis of a prediction model;
wherein the prediction model is designed to achieve a predefined probability of performing the function using the provided redundancy.

5. The method as claimed in claim 1, wherein the mobile unit is configured to inform further mobile units which rules have triggered in the mobile unit and which function is carried out.

6. The method as claimed in claim 1, wherein the request unit is configured to convey the importance and/or urgency of carrying out the function to the mobile unit.

7. A system comprising:
a request unit;
a mobile unit configured to provide functionalities for a function of the request unit required separately from said mobile unit and to carry out said function as required, wherein the function is carried out based on a context; and
a rule engine module formed in the mobile unit and configured to carry out the function on the basis of a context rule system stored in the rule engine module;
wherein the function is carried out in the mobile unit or the function already being carried out is stopped if one or more rules of the context rule system are satisfied.

8. The system as claimed in claim 7, further comprising
a function runtime module formed in the mobile unit and configured to instantiate the function and carry it out in isolation from further functions.

9. The system as claimed in claim 7, further comprising
a context management module formed in the mobile unit and configured to determine the current context of the mobile unit.

10. The system as claimed in claim 7, further comprising
a rule management module formed in the mobile unit and configured to provide the context rule system.

11. The system as claimed in claim 8, further comprising
a function repository module formed in the mobile unit and configured to store the functions which are potentially intended to be carried out and to make them available to the function runtime module.

12. The system as claimed in claim 7, further comprising
a context predictor module formed in the mobile unit and configured to predict the context of the mobile unit.

13. The system as claimed in claim 7, further comprising
a context sensor module formed in the mobile unit and configured to generate information relating to the context.

14. The system as claimed in claim 7, further comprising
a movement, path, coverage and context predictor component and configured to predict contexts for the components of the system and make them available to the mobile unit.

15. The system as claimed in claim 7, wherein
the system comprises an edge cloud and the mobile unit comprises an edge node.
